(19) United States
(12) Patent Application Publication
(10) Pub. No.: US 2007/0012346 A1
(43) Pub. Date: Jan. 18, 2007

(54) SNAPPING MECHANISM OF TELESCOPING TENT POLE

(76) Inventor: Kwan-Jun Choi, KyoungNam (KR)

Correspondence Address: BANGER SHIA, 204 CANYON CREEK, VICTORIA, TX, 77901-3695, US

(21) Appl. No.: 11/277,862

(22) Filed: Mar. 29, 2006

(30) Foreign Application Priority Data
Jul. 15, 2005 (CN) 200520061776.0

(51) Int. Cl. E04H 15/60; F16B 7/10

(52) U.S. Cl. 135/114; 135/120.3; 403/109.1

(57) ABSTRACT

The present invention provides a snapping mechanism of telescoping tent pole typically comprised of a clip ring, a button and an elastic latch; said clip ring has a clamp sleeve formed on one side axially for fastening on the end of external tube of the tent pole, and a housing formed on another side in radial, wherein said button is hinged on the inside of said housing with the upper or low portion, said V-shaped elastic latch is set upon the inside of the inner tube of the tent pole rightly so that a latch bolt extended out from one free end in radial catches into and stretches out via a location hole of the inner tube. Because the V-shaped elastic latch is directly set upon in the inside of the inner tube of the tent pole, just only cooperating to the clip ring integrated with the button set upon the outside can carry out locking and releasing the inner and external tubes function, therefore the clip ring of the snapping mechanism of the telescoping tent pole provided by the present invention saves the space containing the conventional spring, the volume of the clip ring can be designed to smaller, better in looking than the prior art, and the production cost is also lower, and leaves a certain space in use.

### BACKGROUND OF THE INVENTION

1. Field of the Invention

The present invention relates to a snapping mechanism of telescoping tent pole used in big scale tent.

2. Description of Prior Art In accordance with the conventional large scale foldable tent, because pulling out or pushing back the each pole composed of inner and external telescopic tubes need to exerting bigger force, for facilitating to dilatation of each integrated pole, a snapping mechanism is built upon the expansion joint.

A conventional snapping mechanism using in a huge tent pole is shown in FIG. 1 and FIG. 2, which is comprised of a clip ring 1′, a button 2′, a restoring spring 3′ and a location pin 4′; said clip ring 1′ has a clamp sleeve 11′ formed on one side axially for fastening on the end of external tube A, and a housing 12′ formed on another side in radial, said button 2′ is hinged on the middle point of the housing 12′ with the middle portion, said restoring spring 3′ is set up between back side of the upper end of said button 2′ and the bottom side of the housing 12′, and a location pin 4′ is fixed on the back side of another side of the button 2′ for passing through the location holes A1 and B1 of the external and inner tubes A and B to locate them in place. As tending to pitch up the tent, just like drawing out the inner tube B from the external tube A until the location hole B1 of the inner tube B slips to face to the location hole A1 of the external tube A exactly, the location pin 4′ latches into the overlapped location holes A1 and B1 under the restoring force coming from the restoring spring 3′ to lock them together in expending position; and as tending to fold the telescoping pole, such as withdrawing the inner tube B back into the external tube A, just need to press down the upper portion of the button 2′, by the leverage with the pivoted point, the location pin 4′ is pulled out from the location holes A1 and B1 to release the inner and external tubes A and B to carry out folding function.

After studying the same, we are not difficult to find that the location pin and the restoring spring are all assembled into the clip ring 1′, so the whole body of the clip ring 1′ has to offer a certain space for containing them, so that the external volume of the snapping mechanism is became quite big, and the production cost is gone up, and affect to the outline of the pitch-up tent, and occupy a certain space as fold-up.

### OBJECTS AND SUMMARY OF THE INVENTION

It is therefore a main object of the present invention to provide a snapping mechanism of telescoping tent pole, which has a smaller volume and lower production cost than the same, meanwhile guarantee to meet the necessary of carrying out the dilatation operation of huge tent pole smoothly.

This object is achieved by a following resolution provided by the present invention: a snapping mechanism is comprised of a clip ring, a button and a V-shaped elastic latch, said clip ring has a clamp sleeve formed on one side axially for fastening on the end of external tube of the tent pole, and a housing formed on another side in radial, wherein said button is hinged on the inside of said housing with the upper or low portion, said V-shaped elastic latch is set upon the inside of the inner tube of the tent pole rightly so that a latch bolt extended out from one free end in radial catches into and stretches out via a location hole of the inner tube.

Said external tube of the tent pole has a location hole approaching to the end for exactly facing to position of the button.

Utilizing the same, because the V-shaped elastic latch is directly set upon in the inside of the inner tube of the tent pole, cooperating to the clip ring integrated with the button set upon the outside, as tending to pitch up each tent pole just like drawing out the inner tube from the external tube, due to the V-shaped elastic latch located at the inside of the inner tube, and the latch bolt fit into the location hole of the inner tube, when the moving location hole of the inner tube is exactly faced to the location hole of the external tube, under the restoring force of the V-shaped elastic latch, the latch bolt slips into the location hole of the external tube to lock them together; and as tending to fold up the tent pole, just need to press down the button hinged on the clip ring to push the latch bolt back to the inside pressing down the V-spring to release the external tube from the lock state, the inner tube can be pushed back by sliding; so, the clip ring of the snapping mechanism of the telescoping tent pole provided by the present invention saves the space containing the conventional spring, the volume of the clip ring can be designed to smaller, better in looking than the prior art, and the production cost is also lower, and leaves a certain space in use.

### BRIEF DESCRIPTION OF THE DRAWINGS

FIG. 1 is an exploded view of the prior art.

FIG. 2 is a scheme showing the combination state of the prior art.

FIG. 3 is an exploded view of the present invention.

FIG. 4 is a scheme showing the combination state of the present invention.

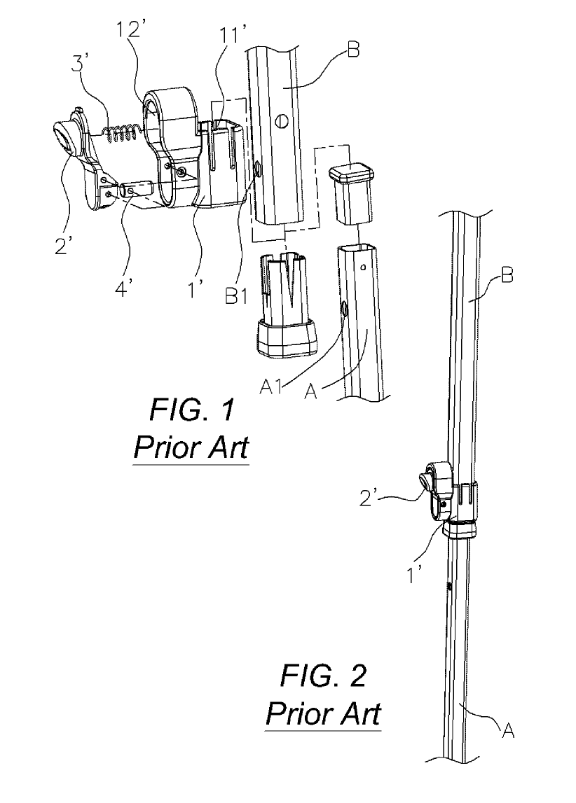

### DETAILED DESCRIPTION OF PREFERRED EMBODIMENTS

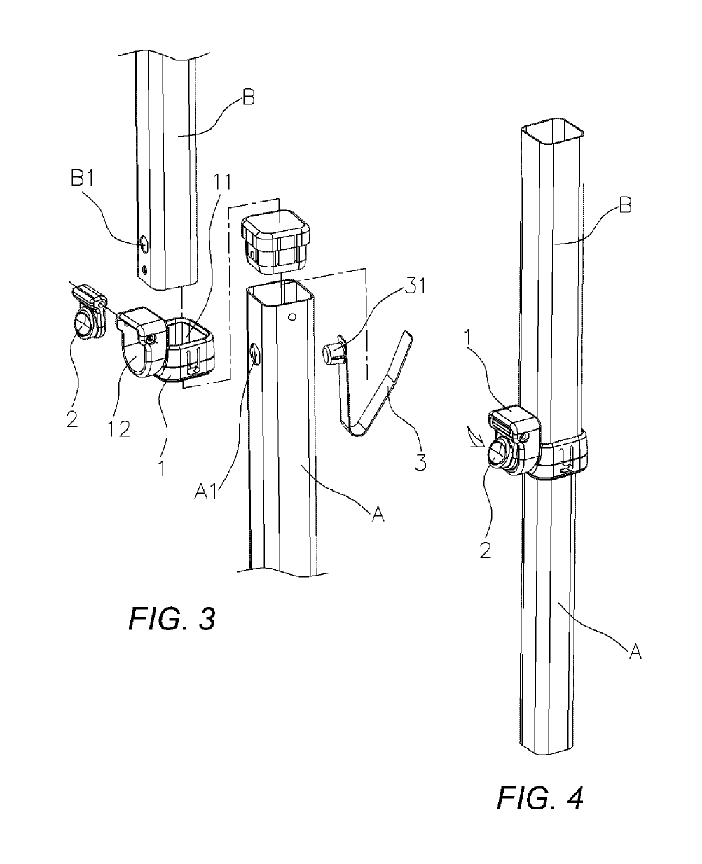

Referring to FIG. 3 and FIG. 4, the snapping mechanism provided by the present invention is typically comprised of a clip ring 1, a button 2 and an elastic latch 3;

Said clip ring 1 has a clamp sleeve 11 formed on one side axially for fastening on the end of external tube B of the tent pole, and a housing 12 formed on another side in radial.

Said button 2 is hinged on the inside of said housing 12 of the clip ring 1 with the upper or low portion, the free portion is exactly facing to a location hole B1 of the external tube B;

Said elastic latch 3 is a V-shaped elastic strip as a V-spring, extending a latch bolt 31 out from a free end outward, said elastic latch 3 is located at inside of the inner tube A by fitting the latch bolt 31 into the location hole A1 and another free end pressing against the back side wall of the hollow inside of the inner tube A.

As tending to pitch up the telescoping tent pole just like drawing out the inner tube A from the external tube B, due to the V-shaped elastic latch 3 located at the inside of the inner tube A, and the latch bolt 31 fit into the location hole Al of the inner tube A, when the moving location hole A1 of the inner tube A is exactly faced to the location hole B1 of the external tube B, under the restoring force of the V-shaped elastic latch 3, the latch bolt 31 slips into the location hole B1 of the external tube B to lock them together in full size state.

As tending to fold up the tent pole just like withdrawing the inner tube A back into the external tube A, just need to press down the button 2 hinged on the clip ring 1 to push the latch bolt 31 back to the inside pressing down the V-spring 3 to release the external tube B from the lock state, the inner tube A can be pushed back into the external tube A by sliding.

In one word, the clip ring of the snapping mechanism of the telescoping tent pole provided by the present invention saves the space containing the conventional spring, the volume of the clip ring can be designed to smaller, better in looking than the prior art, and the production cost is also lower, and leaves a certain space in use.

I claim:

1. A snapping mechanism of telescoping tent pole typically comprised of a clip ring, a button and an elastic latch; said clip ring has a clamp sleeve formed on one side axially for fastening on the end of external tube of the tent pole, and a housing formed on another side in radial, wherein said button is hinged on the inside of said housing with the upper or low portion, said V-shaped elastic latch is set upon the inside of the inner tube of the tent pole rightly so that a latch bolt extended out from one free end in radial catches into and stretches out via a location hole of the inner tube.

2. A snapping mechanism of telescoping tent pole as claimed in claim 1, wherein, said external tube of the tent pole has a location hole approaching to the end for exactly facing to position of the button.
